(19) United States
(12) Patent Application Publication
(10) Pub. No.: US 2015/0380014 A1
(43) Pub. Date: Dec. 31, 2015

(54) METHOD OF SINGING VOICE SEPARATION FROM AN AUDIO MIXTURE AND CORRESPONDING APPARATUS

(71) Applicant: THOMSON LICENSING, Issy de Moulineaux (FR)

(72) Inventors: Luc LE MAGOAROU, Rennes (FR); Alexey OZEROV, Rennes (FR); Quang Khanh Ngoc DUONG, Rennes (FR)

(21) Appl. No.: 14/748,164

(22) Filed: Jun. 23, 2015

(30) Foreign Application Priority Data
Jun. 25, 2014 (EP) 14306003.6

(51) Int. Cl. G10L 25/78; G10L 25/93; G10L 13/00

(52) U.S. Cl. CPC G10L 25/78; G10L 13/00; G10L 25/93

(57) ABSTRACT

Separation of a singing voice source from an audio mixture by using auxiliary information related to temporal activity of the different audio sources to improve the separation process. An audio signal is produced from symbolic digital musical score and symbolic digital lyrics information related to a singing voice in the audio mixture. By means of Non-negative Matrix Factorization (NMF), characteristics of the audio mixture and of the produced audio signal are used to produce an estimated singing voice and an estimated accompaniment through Wiener filtering.

### 1. FIELD

The present disclosure generally relates to audio source separation and in particular to separation of a singing voice from a mixture comprising a singing voice component and an accompaniment component.

### 2. TECHNICAL BACKGROUND

Audio source separation allows separating individual sound sources from a noisy mixture. It is applied in audio/music signal processing and audio/video post-production. A practical application is to separate desired speech from background music and audible effects in an audio mix track of a movie or TV series for audio dubbing. Another practical application is the extracting of a voice from a noisy recording to help a speech recognition system or robotic application, or to isolate a singing voice from an accompaniment in a music mixture that comprises both, for audio remastering purposes or for karaoke type applications. Non-negative Matrix Factorization (NMF) is a well-known technique for audio source separation and has been successfully applied to various source separation systems in a human-supervised manner. In NMF based source separation algorithms, a matrix V corresponding to the power spectrum of an audio signal (the matrix rows representing time frame indexes and the matrix columns representing frequency indexes) is decomposed in the product of a matrix W containing a spectral basis and a time activation matrix H describing when each basis spectra are active. In the single-channel case, i.e. only one audio track is used to separate several sources, the source spectral basis W is usually pre-learned from training segments for different sources in the mixture and then used in a testing phase to separate relating sources from the mixture. The training segments are chosen from an available (different) dataset, hummed, or specified manually through human intervention. In NMF-based source separation algorithms the model parameters (W, H) for each source are estimated. Then these model parameters W and H are used to separate the sources. A good estimation improves the source separation result. The present disclosure tries to alleviate some of the inconveniences of prior solutions by using additional information to guide the source separation process.

### 3. SUMMARY

In the following, the wording ‘audio mix’ or ‘audio mixture’ is used. The wording indicates a mixture comprising several audio sources mixed together, among which at least one desired audio source is to be separated. By “sources” is meant the different types of audio signals present in the audio mix such as speech (human voice, spoken or sung), music (played by different musical instruments), and audible effects (footsteps, door closing . . . ).

Though the wording ‘audio’ is used, the mixture can be any mixture comprising audio, such as an audio track of a video for example.

The present principles aim at alleviating some of the inconveniences of prior techniques by improving the source separation process through the use of specific auxiliary information that is related to the audio mixture. This auxiliary information is comprised of both musical score and song lyrics information. One or more guide audio signals are produced from this auxiliary information to guide the source separation. According to a particular, non-limiting embodiment of the present principles, NMF is used as a core of the source separation processing model.

To this end, the present principles comprise a method of audio separation from an audio mixture comprising a singing voice component and an accompaniment component, the method comprising: receiving the audio mixture; receiving symbolic digital musical score information of the singing voice in the received audio mixture; receiving symbolic digital lyrics information of the singing voice in the received audio mixture; determining at least one audio signal from both the received symbolic digital musical score information and the symbolic digital lyrics information; determining characteristics of the received audio mixture and of the at least one audio signal through nonnegative matrix factorization; and determining an estimated singing voice and an estimated accompaniment by applying a filtering of the audio mixture using the determined characteristics.

According to a variant embodiment of the method of audio separation, the at least one audio signal is a single audio signal produced by a singing voice synthesizer from the received symbolic digital musical score information and from the received lyrics information.

According to a variant embodiment of the method of audio separation, the at least one audio signal is a first audio signal, produced by a speech synthesizer from the lyrics information, and a second audio signal produced by a musical score synthesizer from the symbolic digital musical score information.

According to a variant embodiment of the method of audio separation, the characteristics of the at least one audio signal is at least one of a group comprising: temporal activations of pitch; and temporal activation of phonemes.

According to a variant embodiment of the method of audio separation, the nonnegative matrix factorization is done according to a Multiplicative Update rule.

According to a variant embodiment of the method of audio separation, the nonnegative matrix factorization is done according to Expectation Maximization.

The present principles also relate to device for separation of a singing voice component and an accompaniment component from an audio mixture, the device comprising: a receiver interface for receiving the audio mixture, for receiving symbolic digital musical score information of the singing voice in the received audio mixture and for receiving symbolic digital lyrics information of the singing voice in the received audio mixture; a processing unit for determining at least one audio signal from both the received symbolic digital musical score information and the symbolic digital lyrics information, for determining characteristics of the received audio mixture and of the at least one audio signal through nonnegative matrix factorization; and a filter for determining an estimated singing voice and an estimated accompaniment by filtering of the audio mixture using the determined characteristics.

According to a variant embodiment of the device, it further comprises a singing voice synthesizer for producing a single audio signal from the received symbolic digital musical score information and from the received symbolic digital lyrics information.

According to a variant embodiment of the device, it further comprises a speech synthesizer for producing a first audio signal from the symbolic digital lyrics information, and a musical score synthesizer from the symbolic digital musical score information for producing a second audio signal.

### 4. LIST OF FIGURES

More advantages of the present principles will appear through the description of particular, non-restricting embodiments of the present principles.

The embodiments will be described with reference to the following figures:

FIG. 1 is a workflow of an typical NMF based source separation method.

FIG. 2 is an example matrix factorization in accordance with FIG. 1.

FIGS. 3 and 4 are workflows of a source separation method according to a particular, non-limiting embodiment of the present principles.

FIG. 5 is a non-limiting embodiment of a device that can be used to the method of separating audio sources from an audio signal according to the present principles.

FIG. 6 is a flow chart of a non-limiting embodiment of the present principles.

### 5. DETAILED DESCRIPTION

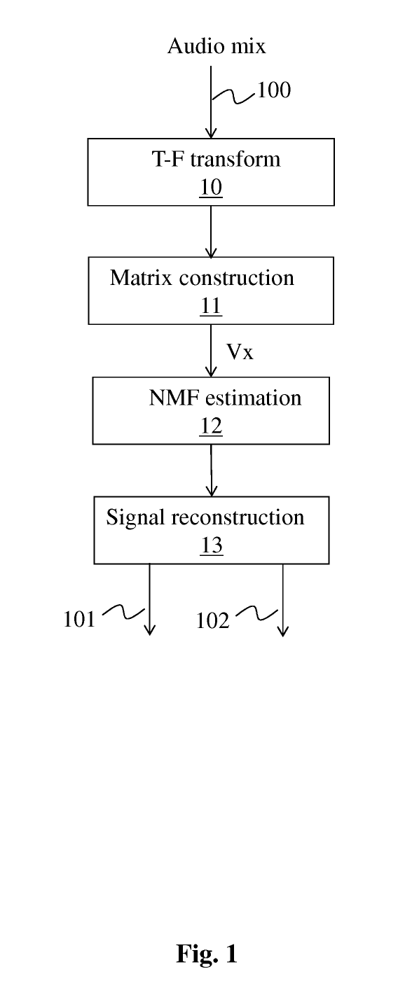

FIG. 1 is a workflow of a typical NMF based source separation method. An input time-domain mixture signal 100 (e.g. speech mixed with background; either single channel or multichannel) is first framed (i.e. put into temporal intervals) and transformed into a time-frequency (T-F) representation by means of a Short Time Fourier Transform (STFT) 10.Then an F-by-N matrix V of the magnitude or squared magnitude sequences is constructed from the T-F representation (11), where F denotes the total number of frequency bins and N denotes the total number of time frames.

The width of a time frame ‘n’ is typically 16 to 64 ms. The width of a frequency bin ‘f’ is typically 16 to 44 kHz. The matrix V is then factorized by a basis matrix W (of size F-by-K) and a time activation matrix H (of size K-by-N), where K denotes the number of NMF components, via an NMF model parameter estimation 12, thus obtaining V=W*H, where * denotes matrix multiplication. This factorization is here described for single channel mixtures. However, its extension to multichannel mixtures is straightforward. Each column of the matrix W is associated with a spectral basis of an elementary audio component in the mixture. If the mixture contains several sources (e.g. music, speech, background noise), a subset of elementary components will represent one source. As an example, in a mixture comprising music, speech and background noise, Cm, Cs, and Cb are elementary components for each source. Then the first Cm columns of W are spectral basis of music, the next Cs columns are spectral basis of speech and the remaining Cb columns are for the noise, and K=Cm+Cs+Cb. Each row of H represents the activation of the spectral coefficients along the time.

In order to help estimating the values in the matrices W and H, some guiding information is needed and incorporated in an initialization step 12, where the spectral basis of different sources, represented in W, are learned from training segments where only a single considered type of source is present. Then the values in matrices W and H are estimated from the mixture via either a prior technique Expectation-Maximization (EM) algorithm or a prior technique Multiplicative Update (MU) algorithm in a step 13. In the next step, the estimated source STFT coefficients are reconstructed in a step 14 via well known Wiener filtering:

$${S}_{j , fn} = \frac{{[ {W}_{j} {H}_{j} ]}_{fn}}{{[ WH ]}_{fn}} {V}_{fn} \qquad ( 0 )$$

where S_{j,fn} denotes the STFT coefficient of source j at time frame n and frequency bin index f; Wⱼ and Hⱼ are parts of the matrix W and H that corresponding to source j, V_{fn} is the value of the input matrix V at time frame n and frequency bin index f.

Finally the time-domain estimated sources are reconstructed by applying well-known inverse short time Fourier transform (ISTFT), thereby obtaining separated sources 101 (e.g. the speech component of the audio mixture) and 102 (the background component of the audio mixture).

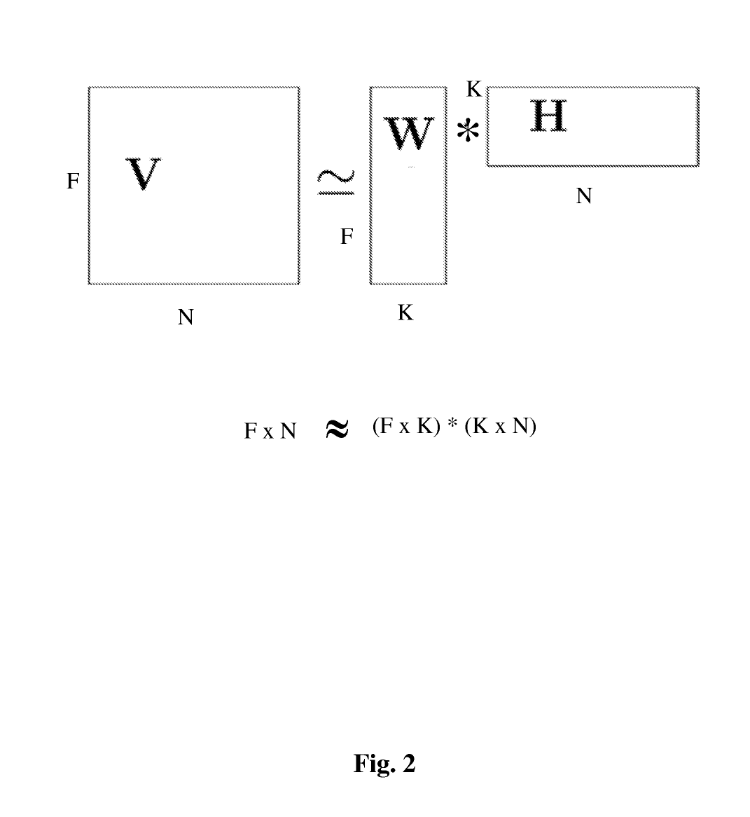

FIG. 2 is an example of a typical matrix factorization, that illustrates how an input matrix V (of the power spectrum) that is computed from the audio mixture is factorized as a product of two matrices W (giving a spectral basis of each elementary audio component in the mixture) and H (matrix that describes when each elementary audio component in the mixture is active).

In an NMF parameter estimation, the parameter update rule is derived from the following cost function:

D(V|WH)=Σ_{f=1}^{F}Σₙ₌₁^{N}d([V]_{fn}|[WH]_{fn}) (1)

This cost function is to be minimized, so that the product of W and H comes close to V. D(V|WH) is a scalar cost function for which a popular choice is Euclidean or Itakura-Saito (IS) divergence, and [X]_{fn} denotes an entry of matrix X (at frequency f and time t).

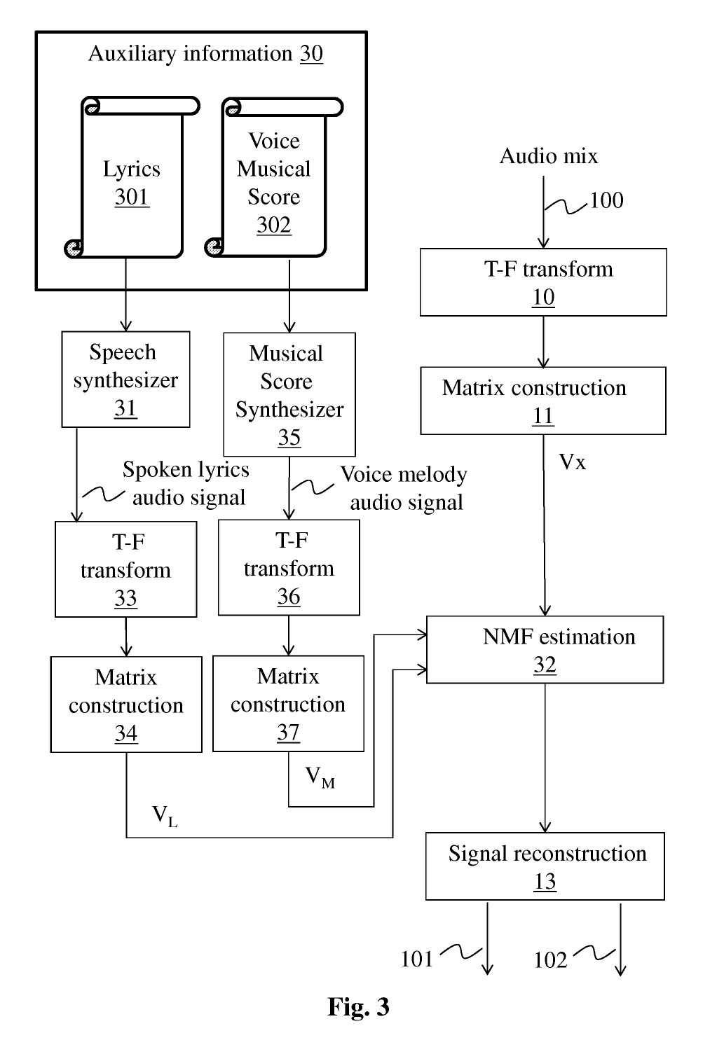

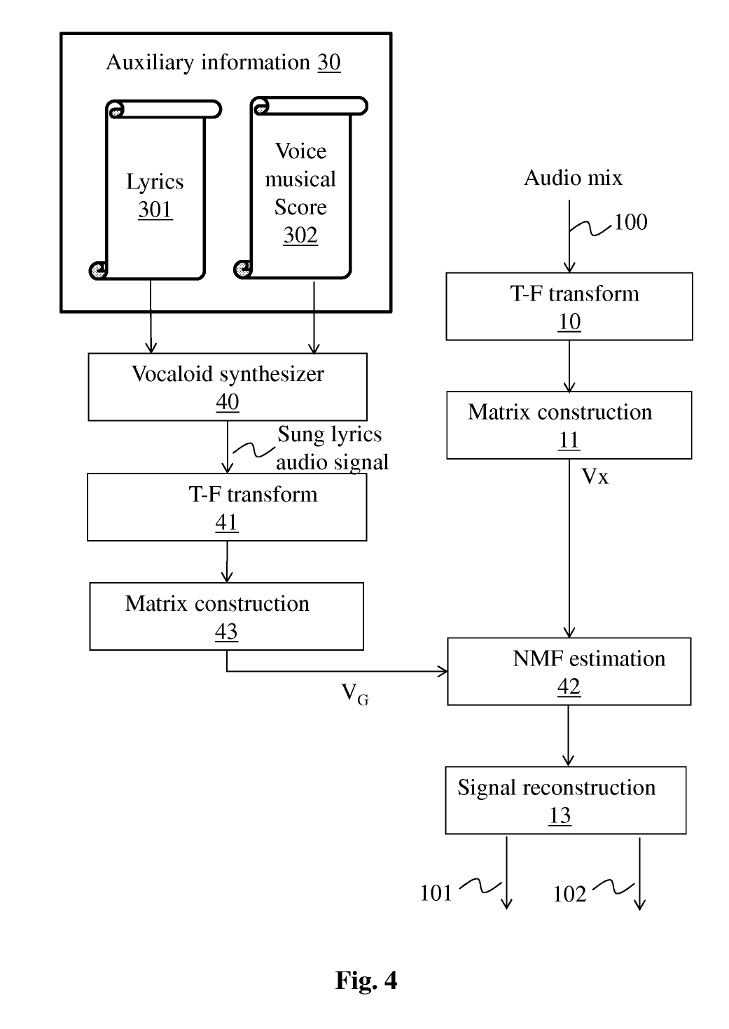

FIGS. 3 and 4 present workflows of a source separation method according to non-limiting embodiments of the present principles. Different types of auxiliary information are considered in an NMF estimation step in order to guide the source separation. The description for elements that have already been described with regard to FIG. 1 having the same reference numerals are not repeated here. Additional information is used here as a guide audio source in an enhanced NMF model parameter estimation step 32/42, in order to guide the NMF parameter estimation. In FIG. 3, lyrics auxiliary information 301 of a singing voice component in the audio mix 100 is input to a speech synthesizer 31. The speech synthesizer produces a spoken lyrics audio signal. The spoken lyrics audio signal is input to a Time-Frequency (STFT, for short-time Fourier transform) transforming step 33, the output of which is fed to a matrix construction step 34 that computes a matrix V_{L} from the spectrograms of the magnitude or square magnitude of the STFT coefficients. The matrix V_{L} is fed to the NMF estimation step. Likewise, the voice musical score auxiliary information 302 is input to a musical score synthesizer 35, which produces a voice melody audio signal, i.e. similar to a human humming a melody. The voice melody audio signal is fed to a T-F (Time-Frequency) transforming step 36, the output of which is fed to a matrix constructing step 37. The matrix constructing step generates a matrix V_{M} that is fed to the NMF estimation step to guide the NMF parameter estimation. In FIG. 4, the lyrics and the voice musical score auxiliary information are input to a singing voice synthesizer or vocaloid 40 to form a combined guide source matrix V_{G} that is input to an NMF parameter estimation step 42 after a T-F transforming step 41 and a matrix constructing step 43. One of the advantages of the variant embodiment of FIG. 4 over those of FIG. 3 is that the matrix V_{G} represents a better guide source than the separately provided guide source matrices V_{M} and V_{L} of FIG. 3. This is because the song lyrics audio signal produced by the vocaloid already comprises all of the pitch and phoneme characteristics in one audio signal, and comes thereby closer to the singing voice in the audio mix than each of the separately provided speech and melody guide source matrices of the embodiment of FIG. 3. For both embodiments, it is desirable to have a valid time synchronization between the lyrics and the voice musical score information for the NMF estimation to function correctly. Therefore synchronization matrices can be introduced in the model, and jointly estimated with the other characteristics. The auxiliary information 301 and 302 can have the form of a textual description for the lyrics 301, and a music sheet for the voice musical score 302. Alternatively, the voice musical score may be in a commonly understood machine readable format such as a SMF file (SMF stands for Standard MIDI File, where MIDI stands for Musical Instrument Digital Interface).

With regard to FIG. 3, it can thus be observed that there are three spectrograms, i.e. guide source matrices V_{M} and V_{L} and mixture source matrix V_{X}. The mixture source matrix V_{X} can be said to be constituted of two matrices, namely V_{S} representing the singing voice and V_{A} representing the accompaniment. The spectrograms of the mixture V_{X}, the synthesized voice musical score V_{M} and the synthesized lyrics V_{L} can thus be modeled in the following equations:

\hat{V}_{X}=(W_{X}^{e}H_{X}^{e})⊚(W_{X}^{φ}H_{X}^{φ})⊚(w_{X}^{c}i_{X}^{T})+W_{B}H_{B}

\hat{V}_{M}=(W_{X}^{e}PH_{X}^{e}D_{M})⊚(W_{M}^{φ}H_{M}^{φ})⊚(w_{M}^{e}i_{M}^{T})

\hat{V}_{L}=(W_{L}^{e}H_{L}^{e})⊚(W_{X}^{φ}H_{X}^{φ}D_{L})⊚(w_{L}^{e}i_{L}^{T}) (2)

Where ⊚ denotes the Hadamard product (in mathematics, the Hadamard product (also known as the Schur product or the entrywise product) is a binary operation that takes two matrices of the same dimensions, and produces another matrix where each element ij is the product of elements ij of the original two matrices) and i is a column vector whose entries are one when the recording condition is unchanged.

V is a power spectrogram and \hat{V} is its model, and we recall that the objective is to minimize the distance between the actual spectrogram and its model.

W^{e}_{X}, W^{e}_{L}, P, i_{X}, i_{M} and i_{L} are parameters that are fixed in advance; H^{e}_{X}, H^{φ}_{X}, and W^{φ}_{X} are parameters that are shared between the mixture and the example signal generated according to the auxiliary information and are to be estimated; the other parameters are not shared and are to be estimated.

W^{e}_{X} is the redundant dictionnary of pitches (tessitura) of the singing voice, that is shared with the melodic example.

P is a permutation matrix allowing a little pitch difference between the singing voice and the melodic example.

H^{e}_{X} is the temporal activations of the pitches for the singing voice, shared with the melodic example.

D_{M} is a synchronization matrix modeling the temporal mismatch between the singing voice and the melodic example.

W^{e}_{L} is the dictionnary of pitches (tessitura) of the lyrics example.

H^{e}_{L} is the temporal activations of the pitches for the lyrics example.

W^{φ}_{X} is the dictionary of phonemes for the singing voice, shared with the lyrics example.

H^{φ}_{X} is the phoneme temporal activations for the singing voice, shared with the lyrics example.

D_{L} is a synchronization matrix modeling the temporal mismatch between the singing voice and the lyrics example.

W^{φ}_{M} is the dictionary of filters for the melodic example.

H^{φ}_{M} is the filter temporal activations for the melodic example.

w^{c}_{X}, w^{c}_{M} and w^{c}_{L} are the recording condition filters of the mixture, the melodic example and the lyrics example respectively.

i_{X}, i_{M} and i_{L} are vectors of ones because the recording conditions are time invariant.

W_{B} is the dictionary of characteristic spectral shapes for the accompaniment.

H_{B} is the temporal activations for the accompaniment.

To summarize, the parameters to estimate are:

θ={H_{X}^{l},D_{M},H_{L}^{l},W_{X}^{φ},H_{X}^{φ},D_{L},W_{M}^{φ},H_{M}^{φ},w_{X}^{c},w_{M}^{c},w_{L}^{c},W_{B},H_{B}} 3)

Estimation of the parameters θ is done by minimization of a cost function that is defined as follows:

C(θ)=λ_{X}d_{IS}(V_{X}|\hat{V}_{X}(θ))+λ_{M}d_{IS}(V_{M}|\hat{V}_{M}(θ))+λ_{L}d_{IS}(V_{L}|\hat{V}_{L}(θ)) (4)

Where

$${d}_{IS} ( x \vert y ) = \frac{x}{y} - log \frac{x}{y} - 1$$

is the Itakura-Saito (“IS”) divergence.

λ_{X}, λ_{M} and λ_{L} are scalars determining the relative importance of V_{X}, V_{M} and V_{L} during the estimation. The NMF parameter estimation can be derived according to either the well known Multiplicative Update (MU) rule or Expectation Maximization (EM) algorithms. Once the model is estimated, the separated singing voice and the accompaniment (more precisely their STFT coefficients) can be reconstructed via the well known Wiener filtering (X(f,n) being the mixture's STFT):

Estimated singing voice:

$$\hat{S} ( f , n ) = \frac{{\hat{V}}_{Sfn}}{{\hat{V}}_{Sfn} + {\hat{V}}_{Afn}} X ( f , n )$$

Estimated accompaniment:

Â(f,n)=(1−α)X(f,n) (5)

According to the variant embodiment of FIG. 4, there is only one guide source power spectrogram V_{G} that is input into the NMF parameter estimation step 42. V_{G} shares with the singing voice in the audio mixture both the melodic and linguistic information. The mathematical model is very similar to that of FIG. 3:

\hat{V}_{X}=(W_{X}^{e}H_{X}^{e})⊚(W_{X}¹⁰⁰ H_{X}^{φ})⊚(w_{X}^{c}i_{X}^{T})+W_{B}H_{B}

\hat{V}_{G}=(W_{X}^{c}PH_{X}^{c}D_{G}_{₁})⊚(w_{X}^{φ}H_{X}^{φ}D_{G}_{₂})⊚(w_{G}^{c}i_{G}^{T}) (6)

This particular embodiment implies the usage of a more sophisticated system than the one of FIG. 3 to produce the example signal from the auxiliary information (lyrics and score), namely a singing voice synthesizer (like vocaloid for example). As the produced example signal is closer to the actual singing voice of the mixture, the source separation performance is better.

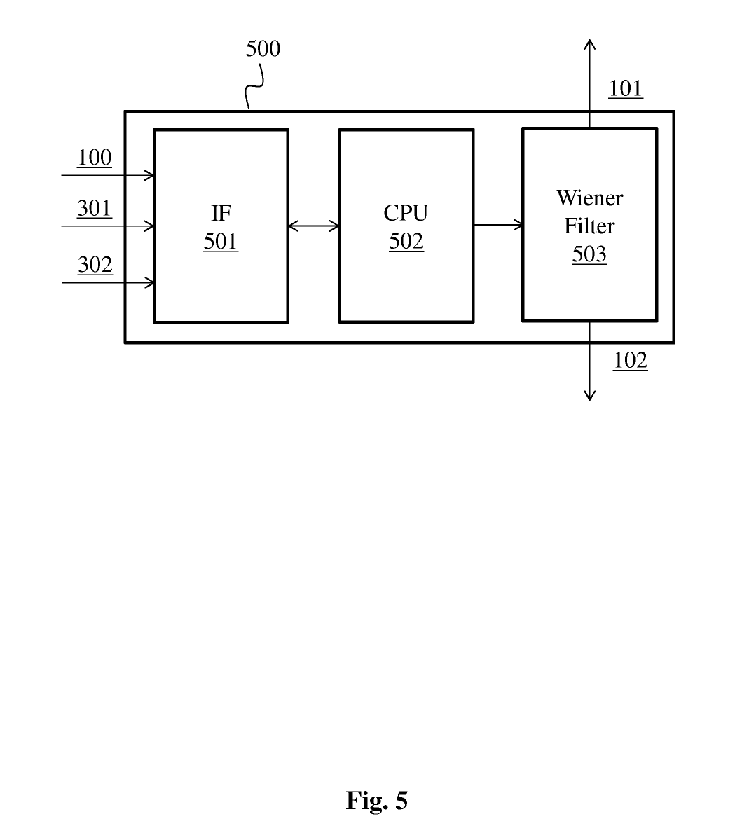

FIG. 5 is a device 500 of a non-limiting embodiment for implementing the method according to the present principles. The device comprises a receiver interface (501) for receiving the audio mixture, for receiving musical score information (302) of the singing voice in the received audio mixture and for receiving lyrics information (301) of the singing voice in the received audio mixture; a processing unit (502) for determining at least one audio signal from both the received song musical score information and the song lyrics information, for determining characteristics of the received audio mixture and of the at least one audio signal through nonnegative matrix factorization; and a Wiener filter (503) for determining an estimated singing voice and an estimated accompaniment by Wiener filtering of the audio mixture using the determined characteristics.

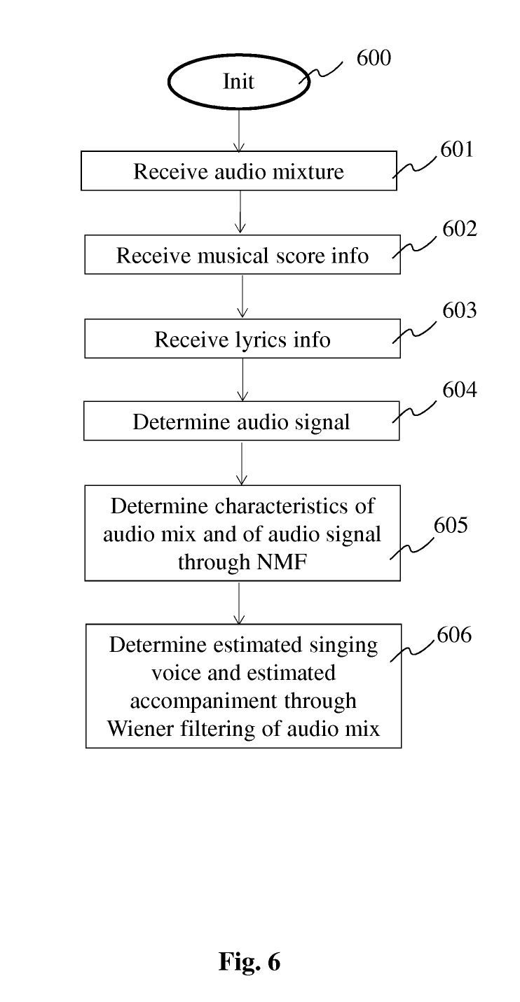

FIG. 6 is a flow chart of a non-limiting embodiment of the present principles. In a first initialization step 600, variables are initialized that are used during the execution of the method. In a step 601 the audio mixture is received. In a step 602 musical score information of the singing voice in the received audio mixture is received. In a step 603 lyrics information of the singing voice in the received audio mixture is received. In a step 604 at least one audio signal is determined from both the received song musical score information and the song lyrics information. In a step 605, characteristics of the received audio mixture and of the at least one audio signal are determined through nonnegative matrix factorization. Finally, in a step 606, an estimated singing voice and an estimated accompaniment are determined by applying a Wiener filtering of the audio mixture using the determined characteristics.

As will be appreciated by one skilled in the art, aspects of the present principles can be embodied as a system, method or computer readable medium. Accordingly, aspects of the present principles can take the form of an entirely hardware embodiment, en entirely software embodiment (including firmware, resident software, micro-code and so forth), or an embodiment combining hardware and software aspects that can all generally be defined to herein as a “circuit”, “module” or “system”. Furthermore, aspects of the present principles can take the form of a computer readable storage medium. Any combination of one or more computer readable storage medium(s) can be utilized.

Thus, for example, it will be appreciated by those skilled in the art that the diagrams presented herein represent conceptual views of illustrative system components and/or circuitry embodying the principles of the present disclosure. Similarly, it will be appreciated that any flow charts, flow diagrams, state transition diagrams, pseudo code, and the like represent various processes which may be substantially represented in computer readable storage media and so executed by a computer or processor, whether or not such computer or processor is explicitly shown.

A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information there from. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

1. A method of audio separation from an audio mixture comprising a singing voice component and an accompaniment component, comprising:
receiving the audio mixture;
receiving symbolic digital musical score information of the singing voice in the received audio mixture;
receiving symbolic digital lyrics information of the singing voice in the received audio mixture;
determining at least one audio signal from both the received symbolic digital musical score information and the symbolic digital lyrics information;
determining characteristics of the received audio mixture and of the at least one audio signal through nonnegative matrix factorization; and
determining an estimated singing voice and an estimated accompaniment by applying a filtering of the audio mixture using the determined characteristics.

2. The method according to claim 1, wherein said at least one audio signal is a single audio signal produced by a singing voice synthesizer from the received musical score information and from the received symbolic digital lyrics information.

3. The method according to claim 1, wherein said at least one audio signal is a first audio signal, produced by a speech synthesizer from said symbolic digital lyrics information, and a second audio signal produced by a musical score synthesizer from said musical score information.

4. The method according to claim 1, wherein said characteristics of the at least one audio signal is at least one of a group comprising:
temporal activations of pitch; and
temporal activation of phonemes.

5. The method according to claim 1, wherein said nonnegative matrix factorization is done according to a Multiplicative Update rule.

6. The method according to claim 1, wherein said nonnegative matrix factorization is done according to Expectation Maximization.

7. A device for separation of a singing voice component and an accompaniment component from an audio mixture, comprising:
a receiver interface for receiving the audio mixture, for receiving symbolic digital musical score information of the singing voice in the received audio mixture and for receiving symbolic digital lyrics information of the singing voice in the received audio mixture;
a processing unit for determining at least one audio signal from both the received symbolic digital musical score information and the symbolic digital lyrics information, for determining characteristics of the received audio mixture and of the at least one audio signal through nonnegative matrix factorization; and
a filter for determining an estimated singing voice and an estimated accompaniment by filtering of the audio mixture using the determined characteristics.

8. The device according to claim 7, further comprising a singing voice synthesizer for producing a single audio signal from the received symbolic digital musical score information and from the received symbolic digital lyrics information.

9. The device according to claim 7, further comprising a speech synthesizer for producing a first audio signal from said symbolic digital lyrics information, and a musical score synthesizer from said symbolic digital musical score information for producing a second audio signal.
